(19) United States
(12) Patent Application Publication
(10) Pub. No.: US 2013/0239691 A1
(43) Pub. Date: Sep. 19, 2013

(54) DEVICE FOR MEASURING THE VIBRATIONS GENERATED IN A MATERIAL

(71) Applicants: Marc Pericoi, Ville D'Avray (FR); Gaetan Boyer, Mas De Londres (FR)

(72) Inventors: Marc Pericoi, Ville D'Avray (FR); Gaetan Boyer, Mas De Londres (FR)

(73) Assignee: PERITESCO, Paris (FR)

(21) Appl. No.: 13/879,119

(22) PCT Filed: Oct. 13, 2011
(86) PCT No.: PCT/IB2011/054525

§ 371 Date: May 30, 2013

(30) Foreign Application Priority Data
Oct. 14, 2010 (FR) 1058363

(51) Int. Cl. G01N 29/04

(52) U.S. Cl. CPC G01N 29/04
USPC 73/649

(57) ABSTRACT

A device (D) for measuring the vibrations generated in a material, includes at least two separate modules, namely: a first module including a sensor provided with a membrane stretched over a rigid part, and a second module including a stressing device capable of generating vibrations by friction inside the material.

### FIELD OF THE INVENTION

The present invention relates to a device for measuring the vibrations generated in a material. It concerns the field of surface state measurement devices.

The present invention is more particularly suitable for use on soft inert materials, biological tissue and in particular skin or hair.

### BACKGROUND OF THE INVENTION

Numerous treatments have been developed for improving the characteristics of the skin. Age and some pathologies also affect these properties. These two points create a demand for devices capable of measuring the characteristics of the skin before and after treatment, or during the monitoring of pathologies or for evaluating the effects of age.

The object of the invention is to measure the vibrations or the noise generated on rubbing the finger or an object on skin or hair or more generally on a material.

### SUMMARY OF THE INVENTION

According to the invention a device for measuring the vibrations generated in a material is characterized in that it includes at least two distinct modules, a first module including a sensor placed on the surface and a second module including a loading device adapted to generate vibrations in the material which rubs on the material.

The first module advantageously includes a resonator isolated from the external environment and equipped with a membrane stretched over a rigid part applied to the material.

The device may include means for guiding the movement of the object that will rub on the surface to be studied.

The movement of the object may be guided by a carriage sliding on rails.

The means for guiding the movement of the object may have a slightly circular shape.

The speed of the gesture may be indicated by indicator lamps.

A material enabling standardization of the surface during rubbing may be fixed to the module.

### BRIEF DESCRIPTION OF THE DRAWINGS

Other features and advantages of the invention will become apparent in the following description of a preferred embodiment with reference to the appended but non-limiting drawings. In these drawings:

FIG. 1 is a diagrammatic perspective view of a device according to the invention.

FIG. 2 is a view similar to FIG. 1 showing the position of the loading finger.

FIG. 3 is a view in section of the device from FIGS. 1 and 2.

FIG. 4 is a view similar to FIG. 3 illustrating an alternative embodiment.

FIG. 5 is a view similar to FIG. 2, illustrating the FIG. 4 embodiment.

### DETAILED DESCRIPTION OF EMBODIMENTS OF THE INVENTION

Throughout the following description of one embodiment of a device according to the invention for measuring the vibrations generated in a material, relative terms such as “upper”, “lower”, “front”, “back”, “horizontal” and “vertical” are to be interpreted when the skin properties measurement device is installed on top of a material to be tested.

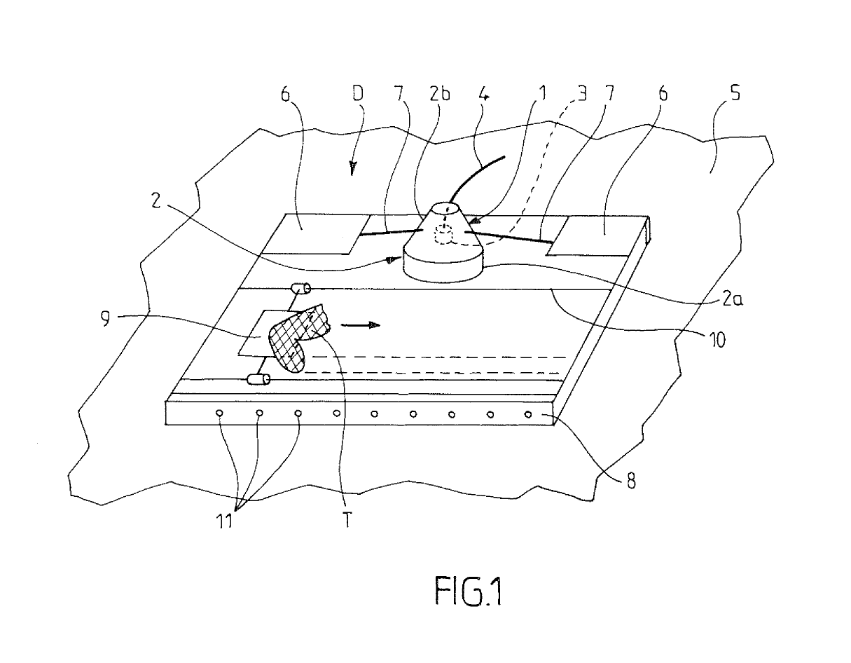

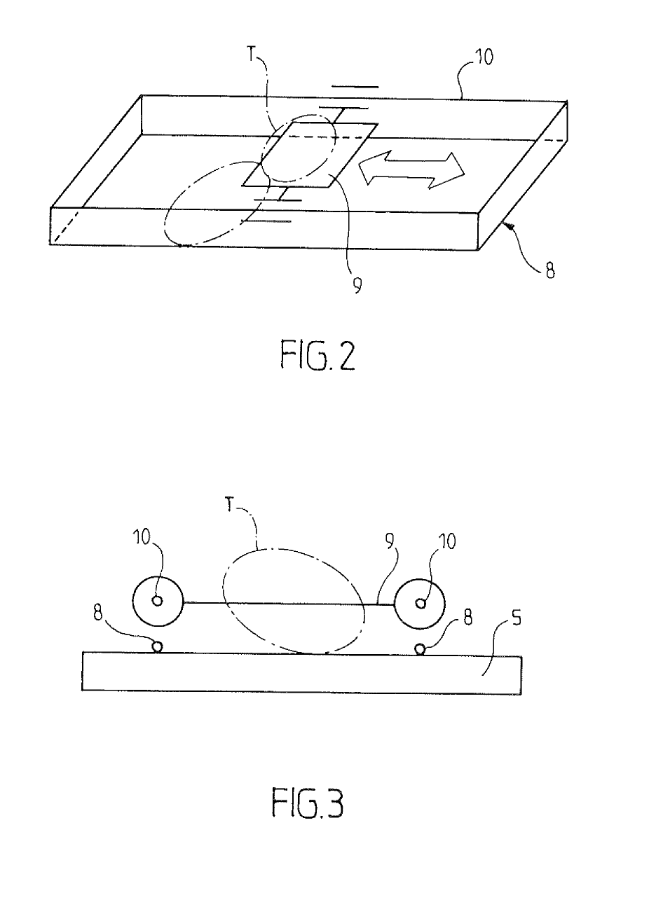

As can be seen in FIG. 1, FIG. 2 and FIG. 3, the device D according to the invention comprises two separate modules or parts.

The first part 1 is the measurement part, which will be composed of a resonator 2 and a sensor 3. A cable 4 connects the sensor 4 to a data acquisition system that is not represented. Data may also be transmitted by means of a wireless technology.

The first part 1 is fixed to the second part 8 by means of shoes 6 and connecting arms 7. The resonator 2 is placed on the surface 5 to be studied, for example the skin, and includes a membrane 2a, placed on the skin, stretched over a rigid part 2b. In one particular embodiment 2b has a substantially conical shape, but any type of shape may nevertheless be envisaged. The membrane 2a may be equally well constituted either of a flexible material or of a rigid material. Inside this rigid part 2b is the sensor 4 measuring the vibrations transmitted by the skin to the membrane 2a and/or the sound emitted into the air by the membrane 2a. The sensor 4 may be situated in the resonator 2, directly on the membrane 2a or fixed to the membrane 2a by means of a component.

The second part 8 is the part guiding movement of the finger T or the object that will rub on the surface 5 to be studied, for example the skin, to generate vibrations.

The second part 8 is situated around the first part 1 and is fixed either rigidly by means of elastic components 7 to the rigid part of the resonator 2. The advantage of an elastic fixing is to isolate from a mechanical point of view the first part 1 from the second part 8 in order to avoid the measurement of vibrations coming from the carriage for example. For the same reason, it is possible for the guide device not to be fixed to the material to be tested.

The first function of the second part 8 is to delimit the area in which the touch is applied i.e. the loading of the surface 5 to be studied. The movement may be either free within this area or guided by a carriage 9 sliding on rails 10 fixed to the second part 8.

The second function of the part 8 is to be able to fix to its lower part a reference material 12 that is situated between the part effecting the touching gesture, i.e. the finger, and the material to be characterized. This material may be a woven fabric or any other type of material. The fixing of such a material makes it possible to standardize the surface characteristics during the touching gesture and to measure only the response of the structure of the characterized material, thus enabling modifications to this structure after application of products to be seen.

A force sensor that is not represented is fixed to the carriage 9.

The speed of the gesture is indicated by indicator lamps 11 fixed to the second part 8 that are lit one after the other at the required speed.

This speed may also be measured by other means such as a carriage movement sensor.

Numerous variants of the device D according to the invention are possible. In particular, where the position of the loading finger movement guide is concerned, the second part guiding the movement may equally well have either a linear shape or a slightly circular shape. This part may be readily interchangeable.

The finger T may be fixed to the carriage 9 or directly guided on the rails 10. It is equally possible not to use any guide device. In this case an operator exerts the loading directly on the material to be tested. To enable reproducible measurements, a drive is necessary.

The thickness of the frame and the carriage is relatively small to guide the fingers at the same time as enabling the pads thereof to touch the material to be characterized. Here the guiding of the carriage is represented diagrammatically by two pivot connections.

The dimensions of the device are relatively small for the method to be applied to slightly curved areas such as the cheek.

The parameters evaluated by this device are the mean level of vibrations generated on touching, the spectral distribution of these vibrations in the frequency domain or the time frequency distribution.

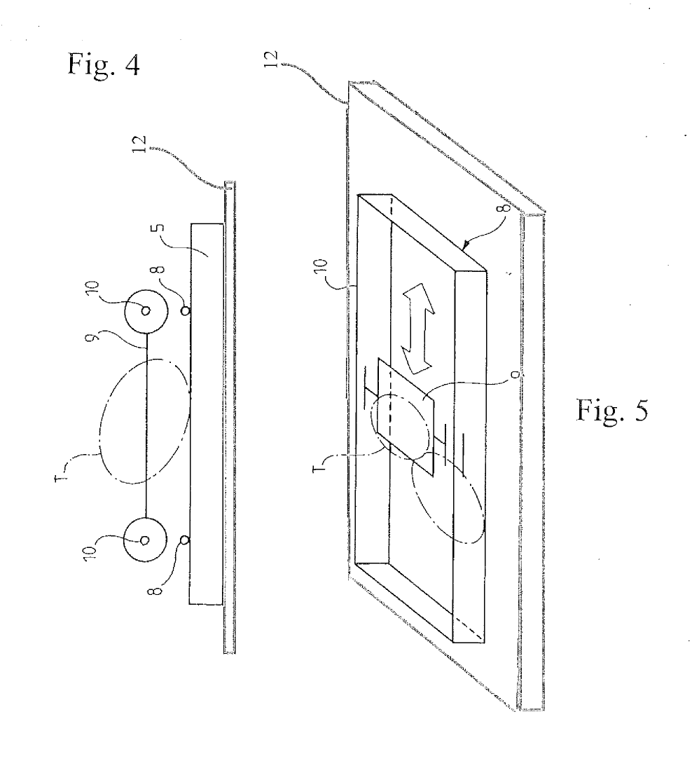

These parameters may correspond to the combination of the surface and the structure of the characterized material or to the structure alone in the case of using a material 12 between the part effecting the touch and the material to be characterized (FIGS. 4 and 5).

The device according to the invention is placed directly on the surface to be studied. In some particular cases the use of a coupling gel is pertinent.

The device according to the invention has the main advantage of enabling decoupling of the measurement part and the loading part. Thus the material may be rubbed by the finger or by mechanized means without having spurious vibrations on the measurement part.

Another advantage that the device according to the invention procures is measuring the vibrations on the material itself, standardizing the surface state, which procures more information on its structure. Moreover, the pressure exerted by the sensor does not vary, only the pressure of the loading possibly changing.

1-7. (canceled)

8. A device (D) for measuring the vibrations generated in a material (5), which comprises: at least two distinct modules, a first module (1) including a resonator and a sensor equipped with a membrane stretched over a rigid part, and a second module (8) including a loading device adapted to generate vibrations in the material (5) which rubs on the material (5), the resonator being placed on the surface (5) to be studied.

9. The device claimed in claim 8, further comprising means for guiding the movement of an object (T) that will rub on the surface (5) to be studied.

10. The device claimed in claim 9, wherein the movement of the object (T) is guided by a carriage (9) sliding on rails (10).

11. The device claimed in claim 9, wherein the means for guiding the movement of the object (T) have a slightly circular shape.

12. The device claimed in claim 8, wherein the speed of the gesture is indicated by indicator lamps (11).

13. The device claimed in claim 8, wherein a material enabling standardization of the surface during rubbing is fixed to the module (8).

14. The device claimed in claim 10, wherein the means for guiding the movement of the object (T) have a slightly circular shape.

15. The device claimed in claim 9, wherein a material enabling standardization of the surface during rubbing is fixed to the module (8).

16. The device claimed in claim 10, wherein a material enabling standardization of the surface during rubbing is fixed to the module (8).
